(19) United States
(12) Patent Application Publication
(10) Pub. No.: US 2026/0229766 A1
(43) Pub. Date: Aug. 6, 2026

(54) ANTENNA, USER EQUIPMENT, WINDOW AND VEHICLE

(71) Applicant: GOERTEK INC., Weifang, Shandong (CN)

(72) Inventors: Katsunori ISHIMIYA, Weifang, Shandong (CN); Katsumi SAITO, Weifang, Shandong (CN)

(21) Appl. No.: 19/150,635

(22) PCT Filed: Sep. 27, 2023
(86) PCT No.: PCT/CN2023/122046

§ 371 Date: Jul. 24, 2025

(51) Int. Cl. H01Q 1/36; H01Q 1/27; H01Q 1/38

(52) U.S. Cl. CPC H01Q 1/364; H01Q 1/273; H01Q 1/38

(57) ABSTRACT

Antennas, user equipment, windows and vehicles are described. Some embodiments may include an antenna including a radiation portion having a first mesh made of conductive material; and a feed portion having a second mesh made of conductive material; wherein a first mesh has a plurality of first mesh holes, and a second mesh has a plurality of second mesh holes; and wherein at least one of the second mesh holes is filled with conductive material. Other embodiments may be described and/or claimed.

### TECHNICAL FIELD

Various embodiments herein generally pertain to the field of wireless communications, and more specifically, to an antenna, user equipment, a window, and a vehicle.

### BACKGROUND

Recent decades have witnessed prosperity of portable user equipment including handheld devices, such as, smart phones, and wearable devices, such as smart watches, virtual reality (VR) devices, augmented reality (AR) devices, extended reality (XR) devices, smart eyeglasses, or goggles. These devices are generally handheld during usage or “worn” as accessories or even apparel on body parts of a user. An increasing requirement on convenient “anytime and anywhere” accesses to the network demands that the user equipment support wireless communications such as Blue-tooth, Wi-Fi, or cellular communications, such as 4G (4^{th} Generation) or 5G (5^{th} Generation). Thus, an antenna has become an essential part of user equipment. However, it is getting harder to achieve both demanded antenna performance and an optimal layout of antenna built in the equipment without changing a fundamental design thereof as the equipment is getting miniaturized and the requirement on the supportable frequency range for the antenna becomes wider.

Therefore, in user equipment which has a transparent portion, such as smart glasses, head mounted display, smartphones, or smart windows, antennas may be disposed on the transparent portion, e.g., a lens, a window, etc., such as to improve dimensions and installation space for the antennas without degrading optical performance of the transparent portion.

### SUMMARY

In some embodiments, the present disclosure may provide an antenna including: a radiation portion having a first mesh made of conductive material; and a feed portion having a second mesh made of conductive material; wherein the first mesh has a plurality of first mesh holes, and a second mesh has a plurality of second mesh holes; and wherein at least one of the second mesh holes is filled with conductive material.

In some other embodiments, the present disclosure may provide user equipment comprising: a lens; a transparent substrate disposed on the lens; and the antenna as described above disposed on the transparent substrate.

In some other embodiments, the present disclosure may provide user equipment comprising: a display; and the antenna as described above disposed on the display.

In some other embodiments, the present disclosure may provide a window comprising the antenna as described above.

In some other embodiments, the present disclosure may provide a vehicle comprising a window and the antenna as described above disposed on the window.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 illustrates a schematic diagram of user equipment (UE) in accordance with some embodiments;

FIG. 2 illustrates a schematic diagram of a mesh shape of the antenna in accordance with some embodiments;

FIG. 3 illustrates a schematic diagram of an antenna in the UE in accordance with some embodiments;

FIG. 4 illustrates a schematic diagram of connection between the antenna and a feeder (a coaxial cable) in accordance with some embodiments;

FIG. 5 illustrates a schematic diagram of connection between the antenna and a feeder (a contact spring) in accordance with some other embodiments;

FIG. 6 illustrates a cross-sectional view of an antenna in the UE taken along line A-A in accordance with some embodiments;

FIG. 7 illustrates a schematic diagram of UE in accordance with some other embodiments; and

FIG. 8 illustrates a schematic diagram of UE in accordance with some other embodiments.

### DETAILED DESCRIPTION OF THE EMBODIMENTS

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc., in order to provide a thorough understanding of the various aspects of the claimed embodiments. However, it will be apparent to those skilled in the art having the benefit of the present disclosure that the various aspects of the embodiments claimed may be practiced in other examples that depart from these specific details. In certain instances, descriptions of well-known devices, circuits, and methods are omitted so as not to obscure the description of embodiments of the present disclosure with unnecessary detail.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

The phrase “in various embodiments,” “in some embodiments,” and the like are used repeatedly. The phrase generally does not refer to the same embodiments; however, it may. The terms “comprising”, “having”, and “including” are synonymous, unless the context dictates otherwise. The phrase “A or B” means (A), (B), or (A and B).

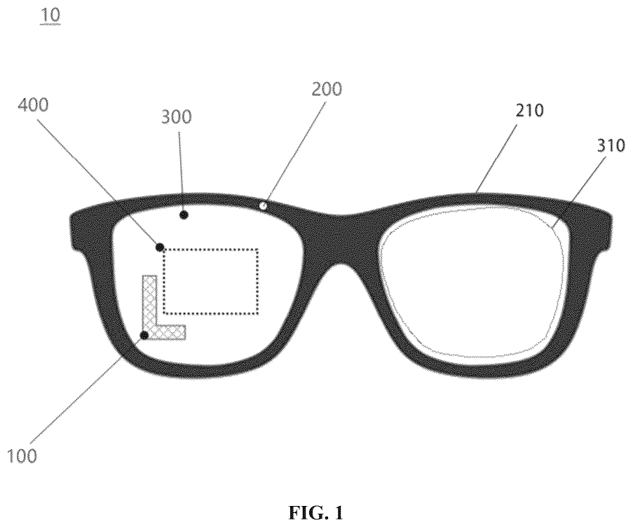

Hereinafter, various embodiments will be described briefly and with reference to FIGS. 1-7.

In some implementations, antenna may be disposed on a transparent portion of UE, such as a lens (e.g., lens of eyeglasses, AR or VR devices, etc.), a window (e.g., window or door glasses of a building or vehicle, etc.), or a display glass (e.g., a display of a smartphone, a see-through or transparent display of a head-up display or digital signage, etc.). In these cases, the antenna may be made less visible in order not to incur reduced transparency of the transparent portion or attract unnecessary attention.

As a possible example, a film antenna may be used as an antenna disposed on the transparent portion. The film antenna may include a transparent substrate, such as, a transparent polyester film, and an antenna layer made of metal foil or the like and disposed on the substrate. The antenna layer of the film antenna may be made of metal, such as, copper or silver, which has better conductivity than that of conductive metallic oxide. However, in such a film antenna, the antenna layer is opaque. In order to reduce the visibility of the antenna layer, the antenna layer may be formed in a mesh shape. The mesh may be a conductive fine wire pattern formed of a plurality of metal wires each having width of, e.g., 1 to 50 μm and thickness of, e.g., 1 to 10 μm. The mesh may be manufactured by etching or printing process but making the mesh finer or denser increases the difficulty in manufacture as compared to the conductive metallic oxide, such as, ITO.

In order to manufacture a transparent antenna at a lower cost without degrading the radiation performance of the antenna, in an example, the mesh may be made denser or solid in a feed portion of the antenna and a region in the vicinity thereof. In another example, an antenna may include a feed portion, a conductive mesh part in a mesh shape and a conductive part formed of a finer mesh than the conductive mesh part, wherein the feed portion may be followed by the conductive part formed of a finer mesh than the conductive mesh part and the part formed of a finer mesh part is immediately followed by the conductive mesh part and wherein the part formed of finer mesh than the conductive mesh part is configured to be bent. However, in these examples, the mesh includes a finer mesh and a coarse mesh, and they are manufactured in sperate steps of etching or printing, which increases the difficulty in manufacture. Further, a failure in current flow, such as, short circuit or open circuit, due to the narrow wires or burying of the wire due to fine wire spaces.

To this end, in some embodiments, an antenna is provided, including: a radiation portion having a first mesh made of conductive material; and a feed portion having a second mesh made of conductive material; wherein a first mesh has a plurality of first mesh holes, and a second mesh has a plurality of second mesh holes; and wherein at least one of the second mesh holes is filled with conductive material. Therefore, the radiation portion having the first mesh may maintain high transparency. In the feed portion having second mesh, some second mesh holes are filled with conductive material, thereby reducing the resistance in the feed portion where the current flow converges and thus improving the current density in the feed portion. Therefore, the radiation performance of the antenna may be prevented from being degraded due to the mesh. In addition, since the second mesh holes is filled with conductive material, the process of making the second mesh in feed portion denser or solider than the first mesh in radiation portion may be omitted, and the first mesh and the second mesh may be manufactured in the same step or process of etching or printing, which reduces the difficulty in manufacture of the antenna. Further, the failure in current flow, such as, short circuit or open circuit, due to the narrow wires or burying of the wire due to fine wire spaces may be prevent. Herein, the antenna may also be called film antenna, mesh antenna, antenna element, or antenna unit, etc. The radiation portion may also be called antenna electrode, electrode pattern, radiation unit or radiation part, etc. The feed portion may also be called feed point, feeding portion or feeding unit, etc.

In some embodiments, the second mesh holes include a plurality of the second mesh holes filled with conductive material and a plurality of the second mesh holes that are unfilled, and the plurality of the second mesh holes filled with conductive material and the plurality of the second mesh holes that are unfilled are alternately arranged. Therefore, the second mesh holes filled with conductive material may be uniformly disposed and the current in the feed portion may be more uniformly distributed. Further, since the second mesh holes filled with conductive material may be uniformly disposed, the transparency may become uniform throughout the feed portion, thereby suppressing the feed portion from attracting user's attention due to its uneven visibility.

In some embodiments, a ratio of the number of the second mesh holes filled with conductive material to a total number of the second mesh holes is 20% to 70%. Therefore, the transparency of the feed portion may be better balanced with the radiation performance of the antenna.

In some embodiments, at least one of the first mesh holes in a vicinity of the feed portion is filled with conductive material. Therefore, the resistance in the vicinity of the feed portion where the current flow converges may be reduced, thereby improving the current density in the vicinity of the feed portion. The vicinity of the feed portion may refer to the transition region between the feed portion and the radiation portion. The first mesh holes in the vicinity of the feed portion may refer to the first mesh holes within a preset distance from the boundary between the feed portion and the radiation portion. The preset distance may be a preset number of the first mesh holes in the direction of away from the boundary. The preset distance and/or the preset number may be set according to the actual practice. In some implementations, the preset number may be set as 1, 2, or more.

In some embodiments, the density of the first mesh holes filled with conductive material may be lower than the density of the second mesh holes filled with conductive material in the vicinity of the feed portion. In some embodiments, the density of the second mesh holes/ and/or first mesh holes filled with conductive material may gradually decrease in a direction away from the contact point between the feeder (e.g., coaxial cable) and the feed portion. In some embodiments, the density of mesh holes filled with conductive material may refer to the number of the second mesh holes or first mesh holes filled with conductive material per unit area. In some other embodiments, if the second or first mesh holes are uniformly filled in the feed portion or the in the vicinity of the feed portion, the density of mesh holes filled with conductive material may also refer to a ratio of the number of the second mesh holes filled with conductive material to the total number of the second mesh holes in the feed portion, or a ratio of the number of the first mesh holes filled with conductive layer to the total number of the first mesh holes in the vicinity of the feed portion. In some embodiments, the density of mesh holes filled with conductive material may refer to the number of the second mesh holes or first mesh holes filled with conductive material per unit length in a predetermined direction. In some other embodiments, if the second or first mesh holes are uniformly filled in the feed portion or the in the vicinity of the feed portion in the predetermined direction, the density of mesh holes filled with conductive material may also refer to a ratio of the number of the second mesh holes filled with conductive material to the total number of the second mesh holes in the predetermined direction, or a ratio of the number of the first mesh holes filled with conductive layer to the total number of the first mesh holes in the vicinity of the feed portion in the predetermined direction.

In some embodiments, a density of the first mesh is equal to that of the second mesh. Thus, the first mesh and the second mesh may be manufactured in the same step or process of etching or printing, which reduces the difficulty in manufacture of the antenna. The density of the mesh may refer to the number of the first mesh holes or second mesh holes per unit area.

In some embodiments, a density of the first mesh is less than that of the second mesh. Thus, the first mesh and the second mesh may also be manufactured in separate steps or processes of etching or printing. Although it increases the difficulty in manufacture to some extent, it can further reduce the resistance in the feed portion where the current flow converges. In addition, the second mesh holes where the failure in current flow due to the narrow wires or burying of the wire due to fine wire spaces has occurred may be filled with the conductive material and thus the failure or burying may be prevented.

In some embodiments, the conductive material includes metal.

In some embodiments, the antenna further includes a ground (GND) portion having a GND contact portion and wherein the GND contact portion is connected to a shield of a coaxial cable and the feed portion is connected to a core of the coaxial cable at the at least one of the second mesh holes filled with conductive material. In this case, the feed portion may be connected to the coaxial cable by various connecting methods, such as soldering. Since the second mesh holes are filled with conductive material as above, the connection between feed portion and the coaxial cable may be stable. Herein, the GND portion may also be called ground, ground portion, grounding portion, etc.

In some embodiments, the antenna further includes a GND portion having a GND contact portion and wherein the GND contact portion is connected to a contact spring and the feeding portion is connected to the contact spring at the at least one of the second mesh holes filled with conductive material. Since the second mesh holes are filled with conductive material as above, the connection between feed portion and the contact spring may be stable.

In some embodiments, the first mesh and the second mesh are integrally formed. As such, the first mesh and the second mesh may be manufactured integrally in the same step or process of etching or printing, which reduces the difficulty in manufacture of the antenna.

In some embodiments, user equipment is provided, including a lens or mirror; a transparent substrate disposed on the lens or mirror; and the antenna as described above disposed on the transparent substrate. The antenna may be used in any user equipment having a lens or mirror, including eyeglasses, a helmet, a monocle, goggles, a headband, or a VR/AR headset, etc. In some embodiments, the antenna is disposed on a surface of the transparent substrate that is away from the lens.

In some embodiments, the lens includes a displaying area, and the antenna is disposed outside the displaying area. Therefore, the antenna may not interfere with image displayed in the displaying area and the displaying quality may be maintained. Herein, the displaying may refer to an area on which a user's field of view concentrates and may also be called a screen area or area of field of view. As an example, when the UE is a device having a display, such as a VR headset, the displaying area may be the main screen area. As another example, when the UE is a device having light projector, such as an AR device, the displaying area may be area of user's field of view.

In some embodiments, the user equipment may further include a housing configured to support the lens and including a portion that convers an edge of the lens. Further the antenna may further include a GND portion. The GND portion may be disposed between the edge and the portion that covers the edge. Thus, the GND portion, which is opaque, may be disposed outside the transparent portion and thus may not interfere with the transparent portion. Furthermore, in some embodiments, the GND portion may be the portion of the housing that covers the edge of the lens. Therefore, spatial occupation of the antenna within the housing may be reduced and compactness of the user equipment may be improved.

In some embodiments, user equipment is provided, including a display or window; the antenna as described above disposed on the display or window. The antenna may be used in any user equipment having a display or window, including smartphones, smart windows, smart showcases, laptop computers, desktop computers, vehicle windows or windshields, etc.

In some embodiments, a window including the antenna is provided. The antenna includes a radiation portion having a first mesh made of conductive material; and a feed portion having a second mesh made of conductive material; wherein a first mesh has a plurality of first mesh holes, and a second mesh has a plurality of second mesh holes; and wherein at least one of the second mesh holes is filled with conductive material. The window may be a window of building, a window of a vehicle, etc.

In some embodiments, a vehicle may be provided, the vehicle may include a window and the antenna disposed on the window. The antenna includes a radiation portion having a first mesh made of conductive material; and a feed portion having a second mesh made of conductive material; wherein a first mesh has a plurality of first mesh holes, and a second mesh has a plurality of second mesh holes; and wherein at least one of the second mesh holes is filled with conductive material. The window of the vehicle may be windshield, side window or rear window.

In some embodiments, a head-mounted device is provided, including: a lens or a display; and an antenna disposed on the lens or the display. The antenna includes a radiation portion having a first mesh made of conductive material; and a feed portion having a second mesh made of conductive material; wherein a first mesh has a plurality of first mesh holes, and a second mesh has a plurality of second mesh holes; and wherein at least one of the second mesh holes is filled with conductive material.

In some embodiments, the radiation portion of the antenna may include: a first radiation portion and a second radiation portion. the first radiation portion may be configured to operate in a first frequency and the second radiation portion is configured to operate in the first frequency and a second frequency. Therefore, the antenna may support multi-band telecommunications.

In some embodiments, the first frequency may be higher than the second frequency.

FIG. 1 illustrates a schematic diagram of user equipment (UE) in accordance with some embodiments. In FIG. 1, UE 10 is shown to be a head-mounted device, such as, AR headsets or VR headsets. The UE 10 includes an antenna 100, a housing 200 and a transparent portion 300 supported by the housing 200.

The antenna 100 is configured for various kinds of communications.

In some embodiments, the antenna 100 may be configured for cellular communications, in accordance with e.g., Global System for Mobile Communication (GSM), General Packet Radio Service (GPRS), Universal Mobile Telecommunications System (UMTS), High Speed Packet Access (HSPA), Evolved HSPA (E-HSPA), Long-Term Evolution (LTE), LTE-Advanced (LTE-A), Enhanced Mobile Broadband (eMBB), Ultra Reliable Low Latency Communications (URLLC), and/or Massive Machine Type Communications (mMTC). The antenna 100 may also be configured for cellular communications in accordance with Enhanced Data for GSM Evolution (EDGE), GSM EDGE Radio Access Network (GERAN), Universal Terrestrial Radio Access Network (UTRAN), or Evolved UTRAN (E-UTRAN). The antenna 100 may be configured for cellular communications in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designed as 3G, 4G, 5G, 6G and beyond.

In some embodiments of cellular communications, before transmitted or after received as electromagnetic waves, the wireless signals may be in a form of an oscillating current or an oscillating voltage at, for example, a radiofrequency (RF) connector for the antenna 100. The RF connector is configured to connect the antenna electrically with RF circuitry, so that the RF circuitry provides a feed to the antenna. In practice, the RF connector may be implemented by on-board wires, an independent cable, or the like.

In some embodiments, the RF circuitry may be coupled with or may be a part of processing circuitry and is configured to convert the oscillating current or the oscillating voltage into a signal compatible with a processing capability of the processing circuitry, or the vice versa. Generally, the conversion is implemented through modulation or demodulation. Specifically, the RF circuitry modulates the oscillating current, or the oscillating voltage based on a signal generated by the processing circuitry, and then the antenna converts the modulated oscillating current or the oscillating voltage into the wireless signals for transmission. Similarly, the antenna coverts the received wireless signals into the oscillating current or the oscillating voltage, and the RF circuitry demodulates the oscillating current or the oscillating voltage to acquire a signal for processing at the processing circuitry. In this embodiment, the processing at the processing circuitry may include, but is not limited to, coding or decoding of visual signals, acoustic signals, or control signals. In practice, the processing circuitry may be implemented in various manners. For example, the processing circuitry may be an application specific integrated circuit (ASIC), a field-programmable gate array (FPGA), a special-purpose chip, or the like. For another example, the processing circuitry is an independent chip mounted on a printed circuit board (PCB), or may be integrated into another chip having multiple functions. The present disclosure is not limited to the above example, and any appropriate chip may serve as the processing circuitry as long as it is capable to process the wireless signals.

The RF circuitry and the processing circuitry are not depicted in FIG. 1. Each of the RF circuitry and the processing circuitry may or may not be a component included in the head-mounted device. That is, the UE may have a capability of signal processing, or may serve as a plug-in unit of another device capable of signal processing, which is not limited herein.

In some embodiments, the antenna 100 may be configured for Wi-Fi communications, though the scope of the embodiments is not limited in this respect. In some of these embodiments, the antenna 100 may be configured to receive and transmit orthogonal frequency division multiplexed (OFDM) or orthogonal frequency division multiple access (OFDMA) communication signals over a multicarrier communication channel. The OFDM or OFDMA signals may include a plurality of orthogonal subcarriers. In some of these multicarrier embodiments, the antenna 100 may be configured to transmit or receive signals in accordance with specific communication standards and/or protocols, such as any of the Institute of Electrical and Electronics Engineers (IEEE) standards including, IEEE 802.11 ln-2009 , IEEE 802.11-2012, IEEE 802.11-2016, IEEE 802.1 lac, and/or IEEE 802.1 lax standards and/or proposed specifications for WLANs, though the scope of aspects is not limited in this respect. The antenna 100 may also be configured to transmit and/or receive communications in accordance with other techniques and standards. In some embodiments, the antenna 100 may be configured for high-efficiency Wi-Fi communications in accordance with the IEEE 802.1 lax standard. In these embodiments, the antenna 100 may be configured to communicate in accordance with an OFDMA technique, though the scope of the embodiments is not limited in this respect.

In some other embodiments, the antenna 100 may be configured to transmit and receive signals transmitted using one or more other modulation techniques, such as, spread spectrum modulation, e.g., direct sequence code division multiple access (DS-CDMA) and/or frequency hopping code division multiple access (FH-CDMA), time-division multiplexing (TDM) modulation, and/or frequency-division multiplexing (FDM) modulation, although the scope of the embodiments is not limited in this respect.

In some embodiments, the antenna 100 may be configured for Bluetooth® (BT) communications and be compliant with a BT connectivity standard such as Bluetooth, Bluetooth 4.0 or Bluetooth 5.0, or any other iteration of the Bluetooth Standard. In these embodiments, the antenna 100 may be configured to establish a BT synchronous connection oriented (SCO) link and/or a BT low energy (BT LE) link. In some of the embodiments, the antenna 100 may be configured to establish an extended SCO (eSCO) link for BT communications. In some of these embodiments, the antenna 100 may be configured to engage in a BT Asynchronous Connection-Less (ACL) communications.

In some embodiments, the antenna 100 may be configured for communication over various channel bandwidths including bandwidth having center frequencies of about 900 MHZ, 2.4 GHz, 5 GHz and bandwidths of about 1 MHz, 2 MHz, 2.5 MHz, 4 MHz, 5 MHz, 8 MHZ, 10 MHz, 16 MHz, 20 MHz, 40 MHz, 80 MHz with contiguous bandwidths or 80+8 QMHz (160 MHz) with non-contiguous bandwidths, though the scope of the embodiments is not limited in these respects. In an example that the antenna 100 is compliant with Wi-Fi standard, the frequency band of the antenna may range from 2.4 GHz to 2.48 GHz, or from 5.15 GHz to 7.15 GHz. In another example that the antenna 100 is compliant with Bluetooth®, the frequency band may range from 2.4 GHz to 2.485 GHz.

In some embodiments, the antenna 100 may be configured as various types, including a monopolar antenna, a slot antenna, a loop antenna, an inverted-L antenna, an inverted-F antenna, a meander antenna and the like, though the scope of the embodiments is not limited in this respect.

The housing 200 may be configured to protect component(s) accommodating therein. The housing 200 may have various designs in different application scenarios in practice and may have another or other part(s) other than what is depicted in the drawings. In some embodiments, the housing may include a cover, a case or casing of a device. In some embodiments (e.g., when the UE is a head-mounted device), the housing 200 may include lens frame, template, etc. In some embodiments, at least a surface of the housing 200 may be curved, bended, or twisted. In some examples, at least a portion of the housing 200 may be solid or filled with materials and/or components. Various components may be disposed in the housing 200 based on an overall design or overall architecture, and hence each of the components occupies a corresponding space in the housing 200. Components other than the antenna 100 and transparent portion 300 are not depicted in FIG. 1 for simplicity of illustration.

The housing 200 may include or made of electrically conductive material. In some embodiments, the portion (such as lens frame) of the housing 200 made of electrically conductive material may constitute the GND portion as described later. In some embodiments, electrically conductive material may include metal. In some embodiments, the metal may include aluminum, magnesium, iron, titan and the like. In other embodiments, the metal may include alloys, such as, stainless steel, magnesium-aluminum alloy and the like. The scope of these embodiments is not limited in these respects. In some embodiments, the housing 200 may include metal frame. In these embodiments, the housing 200 may achieve a sense of luxuriousness for the UE 10.

In some embodiments, the housing 200 may further include non-electrically conductive material. In some embodiments, non-electrically conductive material may include plastic, ceramic, glass, rubber and the like. In some embodiments of using plastic, the plastic may include acrylic or polymethyl methacrylate (PMMA), polycarbonate (PC), polyethylene (PE), polypropylene (PP), polyethylene terephthalate (PETE), polyvinyl chloride (PVC), Acrylonitrile-Butadiene-Styrene (ABS) and the like. The scope of these embodiments is not limited in these respects.

The transparent portion 300 is configured to transmit light or display an image to UE. The transparent portion 300 may be implemented in various forms. In some embodiments, the transparent portion 300 may include a lens. In some embodiments, the transparent portion 300 may include transparent substrate or transparent layer of a display. In some embodiments, the transparent portion 300 may include a window. In some embodiments, the transparent portion 300 may include substrate such as Printed Circuit Board (PCB) or Flexible Printed Circuit Board (FPCB). The scope of the embodiments is not specifically limited in this respect. In some embodiments, the antenna 100 may be disposed on the transparent portion 300, specifically on the substrate, via Optically Clear Adhesive (OCA).

The transparent portion 300 may include non-electrically conductive material. In some embodiments, non-electrically conductive material may include polymer, glass, and the like. In some embodiments of using polymer, the polymer may include polyimide (PI), acrylic or polymethyl methacrylate (PMMA), polycarbonate (PC), polyethylene (PE), polypropylene (PP), polyethylene terephthalate (PETE), polyvinyl chloride (PVC), Acrylonitrile-Butadiene-Styrene (ABS) and the like. The scope of these embodiments is not limited in these respects.

In some embodiments, the transparent portion 300 may further include electrically conductive material. In some embodiments, the electrically conductive material may include metallic oxide. In some embodiments, the metallic oxide may include indium-tin-oxide (ITO), indium-zinc-oxide (IZO), indium-tin-zinc-oxide (ITZO) and the like.

In some embodiments, the transparent portion 300 may include a displaying area 400 to display an image. The antenna 100 may be disposed outside the displaying area 400 on the transparent portion 300, thereby preventing the interference of the antenna with the displaying area and thus not degrading the imaging quality.

In some embodiments (e.g., when the UE is an AR device), the UE 10 may include an image light projecting device installed on the housing 200 (e.g., installed on the lens frame or temple). In this case the transparent portion 300 may have an image light incident area on which image light from the image light projecting device is incident, and the antenna 100 may be disposed outside the image light incident area, thereby preventing the interference of the antenna with the image light incident area and thus not degrading the imaging quality.

In some embodiments (e.g., when the UE is an AR device), the UE 10 may further include a functional lens detachably connected to the housing 200 (e.g., connected to lens frame). The functional lens may include myopic lens, hyperopic lens, polarization lens, etc.

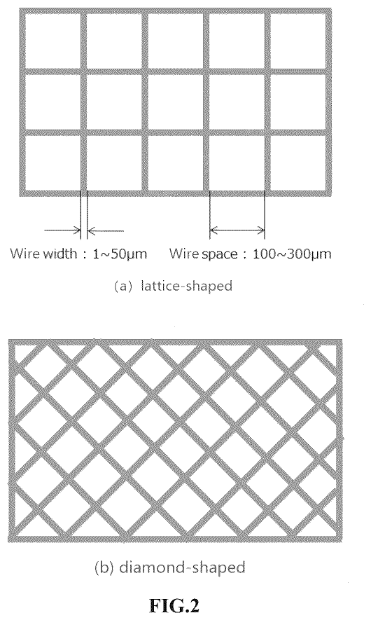

In some embodiments, the antenna 100 may be implemented by conductive wires in mesh shape. FIG. 2 illustrates a schematic diagram of a mesh shape of the antenna in accordance with some embodiments. In some embodiments, the antenna mesh may be lattice shaped as shown in FIG. 2(a) or diamond shaped as shown in FIG. 2(b). In some embodiments, the wire width may be range from 1 to 50 μm, and the space between wires may range from 100 to 300 um.

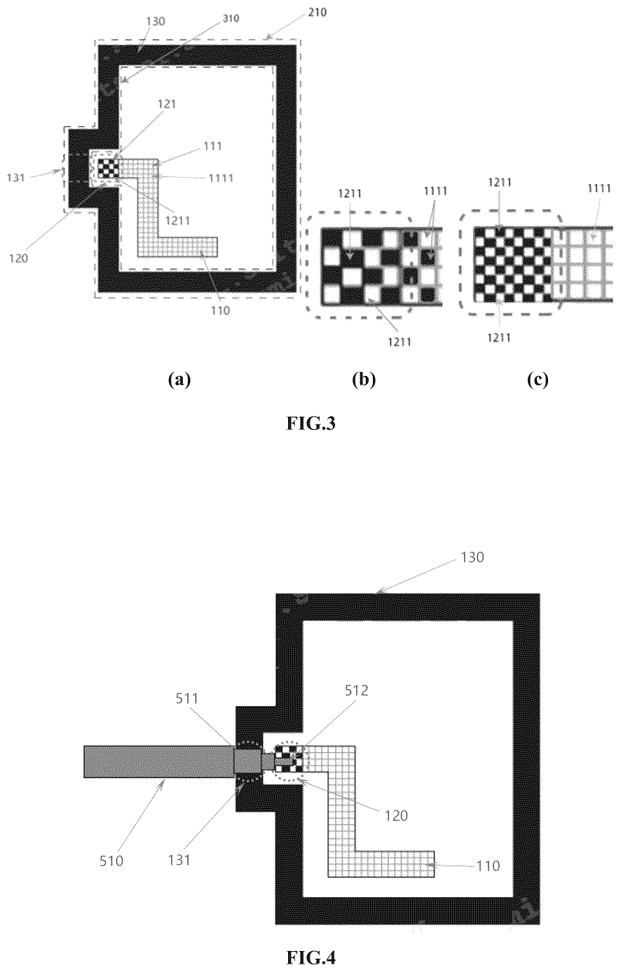

FIG. 3 illustrates a schematic diagram of an antenna in the UE in accordance with some embodiments. The antenna 100 includes: a radiation portion 110 having a first mesh 111 made of conductive material; and a feed portion 120 having a second mesh 121 made of conductive material. The first mesh 111 has a plurality of first mesh holes 1111 and a second mesh 121 has a plurality of second mesh holes 1211. At least one of the second mesh holes 1211 is filled with conductive material. Therefore, the radiation portion 110 having the first mesh 111 may maintain high transparency. In the feed portion 120 having second mesh 121, some second mesh holes 1211 are filled with conductive material, thereby reducing the resistance in the feed portion 120 where the current flow converges and thus improving the current density in the feed portion 120. Therefore, the radiation performance of the antenna 100 may be prevented from being degraded due to the mesh. In addition, since the second mesh holes 1211 are filled with conductive material, to the process of making the second mesh 121 in the feed portion 120 denser or solider than the first mesh 111 in radiation portion 110 may be omitted, and the first mesh 111 and the second mesh 121 may be manufactured in the same step or process of etching or printing, which reduces the difficulty in manufacture of the antenna. Further, the failure in current flow, such as, short circuit or open circuit, due to the narrow wires or burying of the wire due to fine wire spaces may be prevent. In some embodiments, the first mesh 111 and the second mesh 121 may be conductive films, conductive sheets, or conductive lines, and may be implemented in various forms. In some embodiments, the first mesh 111 and the second mesh 121 may be located on a Printed Circuit Board (PCB) or a flexible printed circuit (FPC) in the transparent portion 300. For example, the first mesh 111 and the second mesh 121 may be metallic patterns printed on a flexible film. Devices, elements, circuits, or controllers to collect or send signal from or to the antenna or to control the antenna may be disposed on the Printed Circuit Board (PCB) or a flexible printed circuit (FPC).

In some embodiments, as illustrated in FIG. 3, the second mesh holes 1211 includes a plurality of the second mesh holes 1211 filled with conductive material (as illustrated in black) and a plurality of the second mesh holes 1211 that are unfilled (as illustrated in white), and the plurality of the second mesh holes 1211 filled with conductive material and the plurality of the second mesh holes 1211 that are unfilled are alternately arranged. Therefore, the second mesh holes 1211 filled with conductive material may be uniformly disposed and the current in the feed portion 120 may be more uniformly distributed. Further, since the second mesh holes 1211 filled with conductive material may be uniformly disposed, the transparency may become uniform throughout the feed portion 120, thereby suppressing the feed portion 120 from attracting user's attention due to its uneven visibility.

In some embodiments, the ratio of the number of second mesh holes 1211 which are filled with conductive material to the number of the second mesh holes 1211 may ranges from 20% to 70%, from 30% to 60%, or from 40% to 50%. If the ratio is lower than 20%, the resistance in the feed portion 120 may be too high to achieve high performance. If the ratio is higher than 70%, transparency of the feed portion 120 may be so low as to attract user's attention.

In some embodiments, the conductive material may include metal. In some embodiments, the metal may include copper, silver, aluminum, magnesium, iron, titan and the like. In other embodiments, the metal may include alloys, such as, copper alloy, silver alloy, stainless steel, magnesium-aluminum alloy and the like. The scope of these embodiments is not limited in these respects.

In some embodiments, at least one of the first mesh holes 1111 in a vicinity of the feed portion is filled with conductive material, as shown in FIG. 3(b). Therefore, the resistance in the vicinity of the feed portion where the current flow converges may be reduced, thereby improving the current density in the vicinity of the feed portion. Further, current flow distribution from the feed portion to the radiation portion may gradually change.

In some embodiments, a density of the first mesh 111 is equal to that of the second mesh 121, as shown in FIG. 3(a). Thus, the first mesh and the second mesh may be manufactured in the same step or process of etching or printing, which reduces the difficulty in manufacture of the antenna.

In some embodiments, a density of the first mesh 111 is less than that of the second mesh 121, as shown in FIG. 3(c). Thus, the first mesh and the second mesh may also be manufactured in separate steps or processes of etching or printing. Although it increases the difficulty in manufacture to some extent, it can further reduce the resistance in the feed portion where the current flow converges. In addition, the second mesh holes where the failure in current flow due to the narrow wires or burying of the wire due to fine wire spaces has occurred may be filled with the conductive material and thus the failure or burying may be prevented.

In some embodiments, the conductive material includes metal. In some embodiments, the metal may include copper, silver, aluminum, magnesium, iron, titan and the like. In other embodiments, the metal may include alloys, such as, copper alloy, silver alloy, stainless steel, magnesium-aluminum alloy and the like. The scope of these embodiments is not limited in these respects.

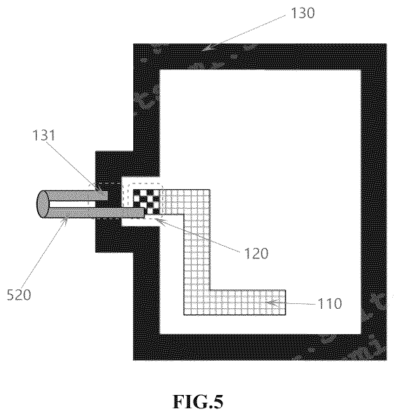

In some embodiments, the antenna further includes a GND portion 130 having a GND contact portion 131. FIG. 4 illustrates a schematic diagram of connection between the antenna and a feeder (a coaxial cable) in accordance with some embodiments and FIG. 5 illustrates a schematic diagram of connection between the antenna and a feeder (a contact spring) in accordance with some other embodiments.

In FIG. 4, the GND contact portion 131 is connected to a shield 511 of a coaxial cable 510 and the feed portion 120 is connected to a core 512 of the coaxial cable 510 at the at least one of the second mesh holes 1211 filled with conductive material. In this case, the feed portion 120 may be connected to the coaxial cable 510 by various connecting methods, such as soldering. Since the second mesh holes 1211 are filled with conductive material as above, the connection between feed portion 120 and the coaxial cable 510 may be stable.

In FIG. 5, the GND contact portion 131 is connected to a contact spring 520 and the feeding portion 120 is connected to the contact spring 520 at the at least one of the second mesh holes 1211 filled with conductive material. Since the second mesh holes 1211 are filled with conductive material as above, the connection between feed portion 120 and the contact spring 520 may be stable.

In some embodiments, as shown in FIG. 1 and 4 the UE 10 may further include a portion (such as lens frame of eyeglasses) 210 that convers an edge 310 of the transparent portion (e.g., lens) 300 and the GND portion 130 may be disposed between the edge 310 and the portion 210 that covers the edge. Thus, the GND portion 130, which may be opaque, may be disposed outside the transparent portion 300 and thus may not interfere with the transparent portion 300. Furthermore, in some embodiments, the portion 210 may include or be made of electrically conductive material and the GND portion 130 may be the portion 210 of the housing that covers the edge 310 of the lens. Therefore, spatial occupation of the antenna within the housing may be reduced and compactness of the UE 10 may be improved.

In some embodiments, the first mesh 111 and the second mesh 121 are integrally formed. As such, the first mesh and the second mesh may be manufactured integrally in the same step or process of etching or printing, which reduces the difficulty in manufacture of the antenna.

The antenna 100 may be tuned to implement wireless communication in various frequency bands. The antenna 100 may be configured to implement a multi-band (such as, dual-band) wireless communications in 2.4-2.48 GHz and 5-7 GHz according to the antenna.

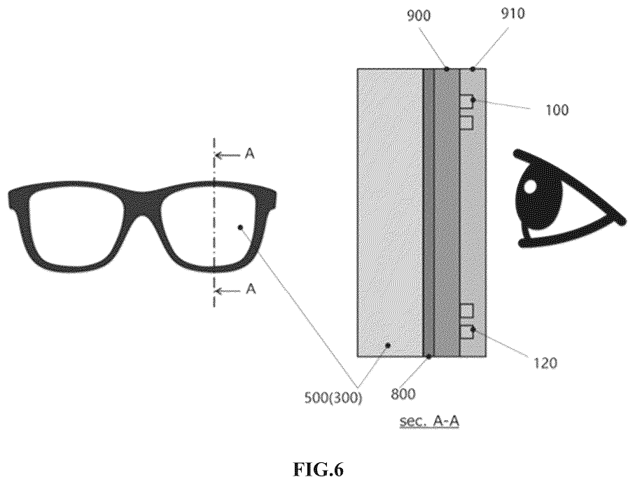

FIG. 6 illustrates a layer structure of a UE in the transparent portion 300 and the antenna, which is cross-sectional view of an antenna in the UE 10 taken along line A-A in accordance with some embodiments. In some embodiments, the UE 10 may be a head-mounted device, such as eyeglasses, a helmet, a monocle, goggles, a headband, or a VR/AR headset, etc. The UE 10 may include a lens 500 (transparent portion 300), a transparent substrate 900 disposed on the lens 500 and the antenna 100 disposed on the transparent substrate 900. The UE 10 may further include an OCA layer 800 disposed between the lens 500 and the transparent substrate 900. The antenna 100 may be disposed on a surface of the transparent substrate 900 away from the lens 500. The UE 10 may further include another layer 910, such as solder resist layer and functional layer (e.g., myopic layer), disposed on the antenna 100. Further, another layer 910 may be disposed between the antenna 100 and the lens 500 and/or a side of the antenna 100 away from the lens 500. Furthermore, another layer 910 may have a plurality of layers or multiple kinds of layers. As an example, another layer 910 may have both a solder resist layer(s) and a functional layer(s). The functional layer may include at least one of a myopic layer, a hyperopic layer, a color filter layer, a polarization layer or the like. As an example, when the UE 10 is a head-mounted device such as AR device, the functional layer may include myopic layer.

It is appreciated that the foregoing embodiments and simulations on specific configuration of the antenna are merely examples. The UE may be implemented in other forms than a head-mounted device, such as smartphones, pagers, laptop computers, desktop computers, smart windows, smart showcases, smart windshield of a vehicle, or any computing device supporting wireless communications. Furthermore, in the embodiments that the UE is a head-mounted device. The head-mounted device may be implemented in other forms than eyeglasses, such as a helmet, a monocle, goggles, a headband, or a VR/AR headset. The antenna may also be applied to any other wearable devices which has lens. The lens and the module may also be implemented in other forms. For example, an electronic helmet may have a mask to bear the image projected from the projector, or other eyeglasses may have a camera located at a right-front or left-front corner for capturing images. Moreover, the antenna may have other shapes or dimensions. Those skilled in the art may apply, various features of antenna described in the above embodiments, mutatis mutandis, to other embodiments or implementations to achieve beneficial effects as described above.

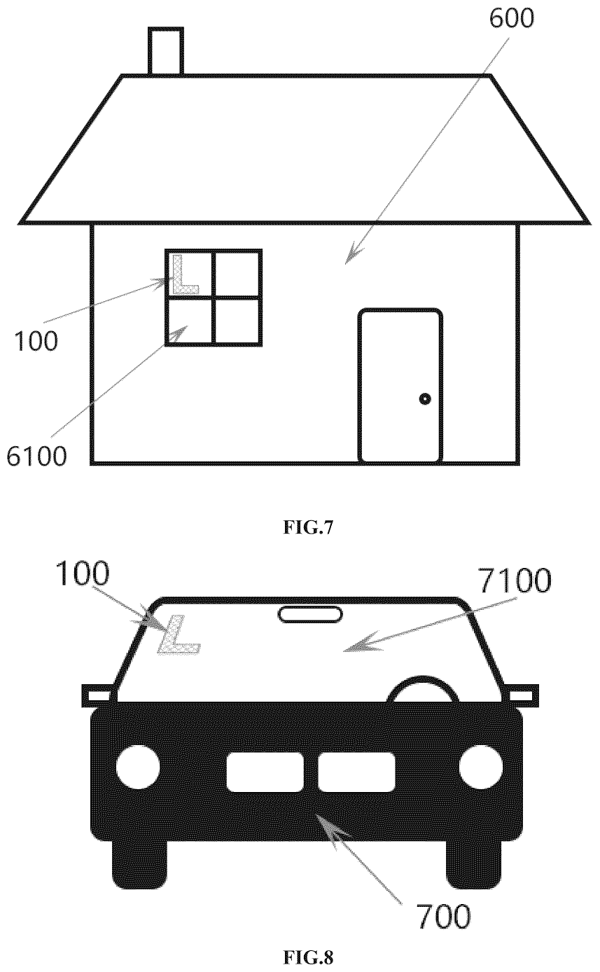

As an example, FIG. 7 illustrates a schematic diagram of UE in accordance with some other embodiments. As another example, FIG. 8 illustrates a schematic diagram of UE in accordance with some other embodiments. In FIG. 6, the UE may be a window 6100 of a building 600 and the antenna 100 may be disposed on the window 6100. In FIG. 7, the UE may be a window 7100, such as windshield, of a vehicle 700, and the antenna 100 may be disposed on the window 7100. As such, the antenna 100 may be applied to any UE including transparent portion 300 or transmitting portion.

The embodiments of the present disclosure are described in a progressive manner, and each embodiment places emphasis on the difference from other embodiments. Therefore, one embodiment can refer to other embodiments for the same or similar parts.

According to the description of the disclosed embodiments, those skilled in the art can implement or use the present disclosure. Various modifications made to these embodiments may be obvious to those skilled in the art, and the general principle defined herein may be implemented in other embodiments without departing from the spirit or scope of the present disclosure. Therefore, the present disclosure is not limited to the embodiments described herein but confirms to the widest scope in accordance with principles and novel features disclosed in the present disclosure.

### INDUSTRIAL APPLICABILITY

Various embodiments may be applied to various user equipment, for example, head-mounted devices such as eyeglasses, helmets, monocles, goggles, headbands, or VR, AR, MR or XR headsets, as well as other user equipment configured for wireless communications, such as smartphones, pagers, laptop computers, desktop computers.

1. An antenna comprising:
a radiation portion having a first mesh made of conductive material; and
a feed portion having a second mesh made of conductive material;
wherein the first mesh has a plurality of first mesh holes, and the second mesh has a plurality of second mesh holes, and
wherein at least one of the second mesh holes is filled with conductive material.

2. The antenna of claim 1, wherein the second mesh holes comprises a plurality of the second mesh holes filled with conductive material and a plurality of the second mesh holes that are unfilled, and wherein the plurality of the second mesh holes filled with conductive material and the plurality of the second mesh holes that are unfilled are alternately arranged.

3. The antenna of claim 1, wherein a ratio of a number of the second mesh holes filled with conductive material to a total number of the second mesh holes is 20% to 70%.

4. The antenna of claim 1, wherein at least one of the first mesh holes in a vicinity of the feed portion is filled with conductive material.

5. The antenna of claim 1, wherein a density of the first mesh is equal to that of the second mesh.

6. The antenna of claim 1, wherein a density of the first mesh is less than that of the second mesh.

7. The antenna of claim 1, wherein the conductive material comprises metal.

8. The antenna of claim 1, wherein the antenna further comprises a ground (GND) portion having a GND contact portion and wherein the GND contact portion is connected to a shield of a coaxial cable and the feed portion is connected to a core of the coaxial cable at the at least one of the second mesh holes filled with conductive material.

9. The antenna of claim 1, wherein the antenna further comprises a GND portion having a GND contact portion and wherein the GND contact portion is connected to a contact spring and the feed portion is connected to the contact spring at the at least one of the second mesh holes filled with conductive material.

10. The antenna of claim 1, wherein the first mesh and the second mesh are integrally formed.

11. User equipment comprising:
a lens;
a transparent substrate disposed on the lens; and
the antenna of claim 1 disposed on the transparent substrate.

12. The user equipment of claim 11, wherein the antenna is disposed on a surface of the transparent substrate that is away from the lens.

13. The user equipment of claim 11, wherein the lens comprises a displaying area and wherein the antenna is disposed outside the displaying area.

14. The user equipment of claim 11, wherein the lens further comprises an image light incident area and wherein the antenna is disposed outside the image light incident area.

15. The user equipment of claim 11, further comprising:
a housing configured to support the lens, and comprising a portion that convers an edge of the lens,
wherein the antenna further comprises a ground (GND) portion disposed between the edge and the portion that covers the edge.

16. The user equipment of claim 11, further comprising:
a housing configured to support the lens, and comprising a portion that convers an edge of the lens,
wherein the antenna comprises a ground (GND) portion, and the GND portion is the portion that covers the edge.

17. The user equipment of claim 11, further comprising:
a housing configured to support the lens; and
a functional lens detachably connected to the housing.

18. The user equipment of claim 11, further comprising:
a functional layer disposed on the transparent substrate.

19. (canceled)

20. A window comprising the antenna of claim 1.

21. A vehicle comprising a window and the antenna of claim 1 disposed on the window.
